(19) United States
(12) Patent Application Publication
(10) Pub. No.: US 2024/0169257 A1
(43) Pub. Date: May 23, 2024

(54) GRAPH-BASED EVENT-DRIVEN DEEP LEARNING FOR ENTITY CLASSIFICATION

(71) Applicant: PAYPAL, INC., San Jose, CA (US)

(72) Inventors: Nitin Sharma, San Francisco, CA (US); Yun-Shiuan Chuang, San Jose, CA (US)

(21) Appl. No.: 18/057,599

(22) Filed: Nov. 21, 2022

(51) Int. Cl. G06N 20/00

(52) U.S. Cl. CPC G06N 20/00

(57) ABSTRACT

Methods and systems are presented for classifying an event conducted by a user based on historic event sequences conducted by the user. For a user whose interaction frequency with a service provider is below the threshold, using just an event sequence of the user to classify an event conducted by the user would not produce a result with an acceptable accuracy. Instead, the event sequence of the user and a set of event sequences of a set of users who are determined to be connected to the user is embedded within a portion of a transaction graph. The transaction graph represents transactions conducted among different users with the service provider. The portion of the transaction graph embedded with the event sequences is provided to a graph-based machine learning model. A classification is determined for the event of the user based on an output of the machine learning model.

### BACKGROUND

The present specification generally relates to machine learning models, and more specifically, to using event sequences to improve the performance of a machine learning model configured to classify events according to various embodiments of the disclosure.

### RELATED ART

A problem that many online service providers face is to distinguish legitimate users from malicious users of their services. As a user is interacting with an online service provider (e.g., logging into a user account, requesting to perform a payment transaction, requesting to access data of the user account, etc.), the online service provider may have to determine, at different points of the interactions (also referred to as different “events”), whether to perform the requested action or not. In other words, the online service provider has to determine whether each event is associated with a fraudulent attempt, such that the online service provider can provide a proper response to the event (e.g., to authorize the transaction, to deny the transaction, etc.).

Conventionally, online service providers use information related to past events of the same type to predict whether an event is associated with a fraudulent attempt. For example, when the event is a login event (e.g., a user requesting to login to a user account), an online service provider may determine whether this particular login event is associated with a fraudulent attempt based on past login transactions (by the same users and/or different users). Various machine learning models may also be used to derive patterns from the past login transactions to predict whether this particular login event is fraudulent or not.

However, by isolating each event according to its event type in the analysis, the machine learning models are limited to information specific to the event without regard to other events that are also associated with the user, which may yield inaccurate or false predictions. As such, there is a need for providing an analysis framework that enables prediction models to consider each user's interactions with the online service provider in a holistic manner.

### BRIEF DESCRIPTION OF THE FIGURES

FIG. 1 is a block diagram illustrating a networked system according to an embodiment of the present disclosure;

FIGS. 2A-2B illustrate example event sequences associated with different users of a service provider according to an embodiment of the present disclosure;

FIG. 3 illustrates different machine learning models for classifying events associated with different users with different interaction frequencies according to an embodiment of the present disclosure;

FIG. 4A illustrates a transaction graph according to an embodiment of the present disclosure;

FIG. 4B illustrates a portion of the transaction graph in a tree format according to an embodiment of the present disclosure;

FIG. 5 is a flowchart showing a process of classifying events according to an embodiment of the present disclosure; and

FIG. 6 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for configuring, training, and utilizing one or more machine learning models to classify an event based on a sequence of events associated with interactions of a user with an online service provider prior to the event. As defined herein, an event may refer to a particular interaction between a user and an electronic user interface (e.g., a website, a mobile application) of an online service provider. Examples of different types of events may include a user logging in to an account with a service provider, a user accessing a particular user interface page (e.g., a particular webpage, a particular mobile application user interface, etc.) of a service provider, a user requesting access to particular data, a user initiating a payment transaction, and other types of interactions between a user and an online service provider.

As discussed herein, conventional event classification systems may use historical data associated with past events of the same type to classify an event. For example, when the event to be classified is a login event (e.g., a user requesting to login to a user account), a conventional event classification system may determine whether this particular login event is associated with a fraudulent attempt based on past login attempts conducted by the same user and/or by different users. The conventional event classification system may analyze attributes associated with the past login attempts, and derive attribute patterns that may correspond to fraudulent login attempts. It may determine, for example, based on analyzing the historical login attempts, that login events that are initiated from a first geographical region are more likely to be associated with fraudulent behavior than login events that are initiated from a second geographical region. Thus, the conventional event classification system may classify login events based on, among other factors, the geographical regions from which the events are initiated.

However, classifying events under such a framework could be ineffective (or producing less than desirable results) if the factors that affect the classification of the events include external factors outside of the event itself. For example, previously conducted events associated with a user that are followed by the event to be classified (e.g., the user interactions of the user and the online service provider prior to the event) may be an important factor in classifying the event. Consider the following two scenarios of two users using similar devices to perform two different sequences of interactions with the online service provider. In the first scenario, a first user accessed a website of the online service provider. Immediately after accessing the website, the first user successfully logged in to a first user account by providing the correct account credentials. The first user then performed a payment transaction of $1,500 through the first user account to Frank. After successfully performing the payment transaction to Frank, the first user initiated another payment transaction of $1,000 through the first user account to Amy.

In the second scenario, a second user accessed the same website of the online service provider. After accessing the website, the second user attempted, and failed, to login to a second user account multiple times, as a result of providing wrong account credentials. The second user finally logged in to the second user account successfully after the multiple failed attempts. The second user then added a new payment instrument (e.g., a new credit card) to the second user account, and attempted to make a purchase (e.g., a transaction of $1,000) using the new payment instrument.

If the payment transaction initiated by the first user and the payment transaction initiated by the second user are analyzed in a vacuum (e.g., by analyzing only the attributes associated with the payment transaction events), a conventional classification system may determine that these two events are similar (based on similar attributes associated with the first and second users, similar attributes associated with the two devices used to conduct the payment transactions, similar monetary amounts associated with the payment transactions, etc.) and would classify them in the same classification (e.g., determining that both events are not associated with fraudulent behavior). However, when the sequence of events leading up to the payment transactions are also analyzed, one can determine that the characteristics surrounding the two payment transactions are very different (e.g., the first scenario follows a common event pattern while the second scenario has an event pattern that may raise red flags due to the large number of failed attempts to login to the user account prior to initiating the payment transaction, etc.), and would likely classify them differently (e.g., determining that the payment transaction initiated by the first user to be benign, and the payment transaction by the second user to be fraudulent). Thus, using the prior events leading up to an event to be classified, instead of or in addition to the attributes of the event itself, may be used to improve the accuracy performance of a classification system in classifying the event.

As such, according to various embodiments of the disclosure, a classification system may classify an event based on a sequence of events associated with a user conducted prior to the event. The sequence of events may represent, in a chronological order, the interactions between the user and the online service provider over a period of time prior to the event and also the event. The event sequences that are used by the classification system to classify the event can be of mixed event types, where one or more of the prior events may be of the same type or different type as the event to be classified. For example, using the two scenarios described above, if the event to be classified for the first user in the first scenario is the payment transaction to Amy, the sequence of events prior to (and leading up to) the initiation of the payment transaction to Amy may be used by the classification system for classifying the event associated with the payment transaction to Amy. In the first scenario, the prior events may include a website access event (e.g., the first user accessing the website), a login event (e.g., the first user successfully logging in to the first user account), and a first payment transaction event for Frank (e.g., the first user successfully performing a payment transaction to Frank through the first user account). Based on this event sequence associated with the first user, the classification system may determine that the payment transaction to Amy is not associated with a fraudulent attempt, and may authorize the payment transaction.

In the second scenario, if the event to be classified for the second user is the payment transaction, the classification system may analyze the previously conducted events leading up to the payment transaction, which may include a website access event (e.g., the second user accessing the website), multiple failed login attempt events (e.g., the second user attempting and failing to login to the second user account), a login success event (e.g., the second user successfully logging in to the second user account), and an adding a new payment instrument event (e.g., the second user adding a new payment instrument to the second user account). Based on this event sequence, the classification system may determine that the payment transaction initiated by the second user is associated with a fraudulent attempt, and may deny the payment transaction.

In some embodiments, the classification system may use one or more machine learning models for classifying events based on sequences of previously conducted events (also referred to as “event sequences” herein). The one or more machine learning models may allow inputs corresponding to a temporal dimension (e.g., time-based machine learning models), such that events conducted at different points in time may be provided to the models as input data. Example machine learning models that can be configured to receive inputs having a temporal dimension may include a recurrent neural network, a long short-term memory (LSTM) neural network, a transformer neural network, a gated recurrent unit (GRU) neural network, etc. The classification system may iteratively provide event data associated with each event in an event sequence, in the order of the events included in the event sequence, as input data to one of these machine learning models. These machine learning models may then use data associated with the different events and also the order (and timing) of the events in the event sequence to generate an output. In some embodiments, the event data associated with each event may include attributes associated with the corresponding event, which may include a point in time when the event was conducted, an event type associated with the event, attributes associated with the corresponding event (e.g., an amount associated with a payment transaction event, credential data used in a login attempt event, a link being selected by a user in a browsing event, etc.), and/or other information related to the corresponding event. As such, using these types of machine learning models enables the classification system to take into account the characteristics of an event sequence leading up to an event for classifying the event.

When a request to classify an event conducted by a user is received, the classification system may retrieve data associated with a sequence of events conducted by the user. The sequence of events may include the event to be classified and events conducted by the user within a predetermined time period prior to the event. The classification system may provide the data associated with the sequence of events to the one or more machine learning models for classifying the event. In some embodiments, the classification system may determine which prior events to be included in the analysis based on different factors, such as a risk level associated with the event. For example, when the risk level of the event is higher (e.g., a payment transaction is associated with a higher amount, accessing data that is of higher sensitivity, etc.), the classification system may determine to include a larger number of events (e.g., inclusion of events conducted during a longer period of time prior to the event to be classified, such as a month, six months, etc.), and when the risk level of the event is lower (e.g., a payment transaction is associated with a lower amount, accessing data is of lower sensitivity, etc.), the classification system may determine to include a smaller number of events (e.g., inclusion of events conducted during a shorter period of time prior to the event to be classified, such as a day, two weeks, etc.).

The sequence of events conducted by the user prior to the event to be classified can be a reliable source of information for classifying the event, especially when the user has a long and dense history of interacting with the online service provider. However, when a user is a new user to the online service provider, or the user is a low frequency user, (that is, when the volume of the event data in the sequence of events is smaller than a threshold), the reliability of the sequence of events as a source of information for classifying the event may be reduced, and the accuracy performance of the classification system may suffer (e.g., may not produce results with acceptable accuracy). In some embodiments, in order to improve the accuracy performance of the classification system, especially for lower frequency users of the online service provider, the classification system may use different machine learning model structures for performing event classification for different users. For example, for high frequency users (e.g., users having an interaction frequency with the online service provider above a first threshold, users having a historic sequence of events longer than a first threshold, etc.), the classification system may use a first machine learning model that can be implemented, for example, as a transformer neural network or a stateful LSTM neural network for performing event classification. For low frequency users (e.g., users having an interaction frequency with the online service provider above a second threshold but below the first threshold, users having a historic sequence of events longer than a second threshold but shorter than the first threshold, etc.), the classification system may use a second machine learning model that can be implemented, for example, as a stateless LSTM neural network or a GRU neural network for performing event classification.

In addition, for new users to the online service provider or users who are mostly inactive and/or dormant (e.g., users having an interaction frequency with the online service provider below the second threshold, users having a historic sequence of events shorter than the second threshold, etc.), the classification system may determine that the data associated with the prior event sequence alone may not be sufficient to produce a classification prediction with acceptable accuracy. Thus, for the inactive and/or dormant users, the classification system may use a third machine learning model that can be implemented, for example, as a memory augmented neural network for performing event classification. The memory augmented neural network enables the classification system to inject additional data that is not part of the event sequence of a user into the model, to assist the event classification process. In some embodiments, when classifying an event for a user, the classification system may determine one or more other users who share common attributes with the user (e.g., common demographic attributes, common income levels, common geographical areas, etc.), and may extract event pattern data from the one or more other users. The classification system may then inject data associated with the extracted event patterns into the memory augmented neural network for performing the event classification for the user. The neural network having the augmented data associated with other similar users improves the accuracy performance of the machine learning model in performing the event classification for the user.

However, even with the augmented data, the accuracy performance of the machine learning model may still be below an acceptable level. As such, in some embodiments, the classification system may further improve the accuracy performance of the machine learning model in performing event classification for a user who is new, inactive, and/or dormant (referred to as an “inactive user”) by using not only the event sequence associated with the inactive user, but also event sequences associated with one or more other users that are related to the inactive user (e.g., users who have performed transactions with the inactive user). For example, the classification system may access a transaction graph associated with the online service provider. The transaction graph may represent transactions (or transaction attempts) conducted by users of the online service provider. In some embodiments, the transaction graph may include nodes representing various user accounts of users with the online service provider. Every transaction conducted between two user accounts may be represented by an edge connecting two nodes corresponding to the two user accounts. By traversing the transaction graph, the classification system may determine user accounts that are related to each other through one or more edges.

When the classification system receives a request for classifying an event conducted by a first user, the classification system may first determine whether the first user is an inactive user (e.g., whether the interaction frequency of the first user with the online service provider is below the second threshold, etc.). If the first user is an inactive user, the classification system may access a transaction graph associated with the online service provider. The classification system may identify a first node within the transaction graph that represents the first user. The classification system may also retrieve a first event sequence associated with the first user using the techniques described herein, the first event sequence including events conducted by the first user during a predetermined period of time leading up to the event. In some embodiments, the first event sequence may also include the event to be classified. In some embodiments, the classification system may embed data associated with the first event sequence into the first node. In some embodiments, the classification may encode the data associated with the first sequence of events, and may embed the encoded data into the first node.

The classification system may then traverse the transaction graph from the first node corresponding to the first user, and may identify a first layer of nodes directly connected to the first node in the transaction graph. The first layer of nodes represents a first set of user accounts that have direct relationships with the first user (e.g., having conducted transactions with the first user via the online service provider in the past). The classification system may retrieve (or generate) a first set of event sequences conducted through the first set of user accounts during the predetermined period of time. Each event sequence in the first set of event sequences represents events conducted by a corresponding user during the predetermined period of time (e.g., the same time period associated with the first event sequence of the first user). The classification system may embed data associated with the first set of event sequences into the respective nodes in the first layer of nodes in the transaction graph.

In some embodiments, the classification system may identify additional nodes in the transaction graph for classifying the event for the first user. For example, the classification system may continue to traverse the transaction graph outward from the first layer of nodes to identify additional nodes that are related to the first node. For example, the classification system may identify a second layer of nodes that are directly connected to one or more nodes from the first layer of nodes in the transaction graph. The second layer of nodes represents a second set of user accounts that have direct relationships with users represented by the first layer of nodes (e.g., having conducted transactions with the users represented by the first layer of nodes via the online service provider in the past). The classification system may retrieve (or generate) a second set of event sequences comprising events conducted through the second set of user accounts during the predetermined period of time, and may embed data associated with the second set of event sequences into the respective nodes in the second layer of nodes in the transaction graph. The classification system may continue to identify a third layer of nodes, a fourth layer of nodes and so forth until the classification system has reached a predetermined number of layers of nodes for the event classification process. In some embodiments, the classification system may determine the number of layers of nodes to include for analyzing the event for the first user based on attributes associated with the event (e.g., a risk associated with the event, etc.), such that the higher the risk associated with the event, the higher number of layers of nodes is determined for the event classification process.

After identifying the nodes that are related to the first node in the transaction graph, and embedding event sequences into the nodes, the classification system may extract a portion of the transaction graph that includes the first node and all of the identified nodes (including all of the embedded data associated with the event sequences), and provide the portion of the transaction graph, as input data, to a graph-based machine learning model. The graph-based machine learning model is configured and trained to analyze the data within the portion of the graph provided as input and to produce an output corresponding to a classification of the event conducted by the first user.

In some embodiments, the graph-based machine learning model may first analyze the first node representing the first user. For example, the graph-based machine learning model may compute a first score based on the event sequence embedded within the first node, and other attributes of the first user stored in the first node. The graph-based machine learning model may then compute a second score based on the event sequences embedded within the first layer of nodes, and attributes of the users stored in the first layer of nodes. In some embodiments, the graph-based machine learning model may apply a first weight to the second score. If the portion of the graph includes additional layers of nodes (e.g., a second layer of nodes, a third layer of nodes, etc.), the graph-based machine learning model may compute an additional score for each layer of nodes. For example, the graph-based machine learning model may also computer a third score based on the event sequences embedded within the second layer of nodes and other attributes of users stored in the second layer of nodes, and a fourth score based on the event sequences embedded within the third layer of nodes and other attributes of users stored in the third layer of nodes. The graph-based machine learning model may also apply different weights to the different scores, where the weight applied to each score is smaller when the layer of nodes is farther away from the first node. Thus, a second weight being applied to the third score may be smaller than the first weight being applied to the second score. The graph-based machine learning model may then compute a final score (the output value) based on the different scores. The classification system may then classify the event of the first user based on the output of the graph-based machine learning model.

Since an inactive and/or dormant user lacks sufficient prior event data for the classification system to produce accurate (e.g., above an acceptable accuracy performance) event classification for the user, the inclusion of event data corresponding to sequences of events conducted by other users who may be directly and/or indirectly related to the user may enrich the insufficient event data associated with the user, which would significantly improve the accuracy performance of the classification system.

Typically, the more nodes to be included within the portion of the graph for classifying the event, the more accurate the classification by the classification system. However, some of the nodes may represent a user (or an account) that may not be beneficial, and can even be disadvantageous, in the classification process for the first user. For example, the first user may have conducted transactions with a large volume merchant (e.g., a merchant having a sales volume larger than a threshold). Since the merchant is a large volume merchant that generally has no particular relationship or ties with the first user, the inclusion of the node representing the large volume merchant may not be advantageous in the analysis. Furthermore, since the large volume merchant has a large number of consumers, the node representing the large volume merchant in the transaction graph inevitably connects to a large number of nodes, representing various users who have conducted transactions with the large volume merchant. These users likely have little or no relationship to the first user, and the inclusion of such a large number of nodes in the graph would further reduce the computer processing efficiency of performing the classification. Thus, the classification system of some embodiments may determine whether the portion of the graph includes a node that represents a large volume merchant, and may remove a section of the portion of the graph based on the node representing the large volume merchant in order to further improve the accuracy and efficiency of the event classification process.

The use of event sequences that are embedded within a transaction graph enables the classification system to perform event classification quickly (e.g., in real-time), such that the classification system can continuously perform event classifications for evaluating interactions of a user as the user interacts with the online service provider. For example, during an online session between the user and the online service provider, the user may conduct multiple events at different points in time. The user may first access a webpage of the online service provider, and then login to a user account with the online service provider. The user may navigate to a particular webpage of the website and conduct a payment transaction with another user. In some embodiments, the online service provider may use the classification system to evaluate each of those events (e.g., the website access event, the login event, the navigation event, and the payment transaction event, etc.), and may provide proper responses to the user's requests in real-time based on the classifications of the events. In other words, the user may be evaluated throughout the interactions, such that a malicious intent of the user may be detected as quickly as possible, and possibly before the user conducts a critical event (e.g., an event that has a high level of sensitivity such as accessing highly sensitive data, performing a payment transaction, etc.). This way, the online service provider may determine that the user is a malicious user based on the classification of events conducted by the user and perform appropriate responses to the user (e.g., locking the user out of a user account, denying further transaction requests by the user, etc.) before the user has a chance to cause substantial damages (e.g., by initiating critical events with the service provider), thereby improving the overall security of the user interface platform of the online service provider. Furthermore, since the machine learning models used by the classification system are domain-independent (e.g., capable of classifying different types of events), the use of the same machine learning models to perform classification for all of the events during the online session further improves efficiency and accuracy performance of the classification system.

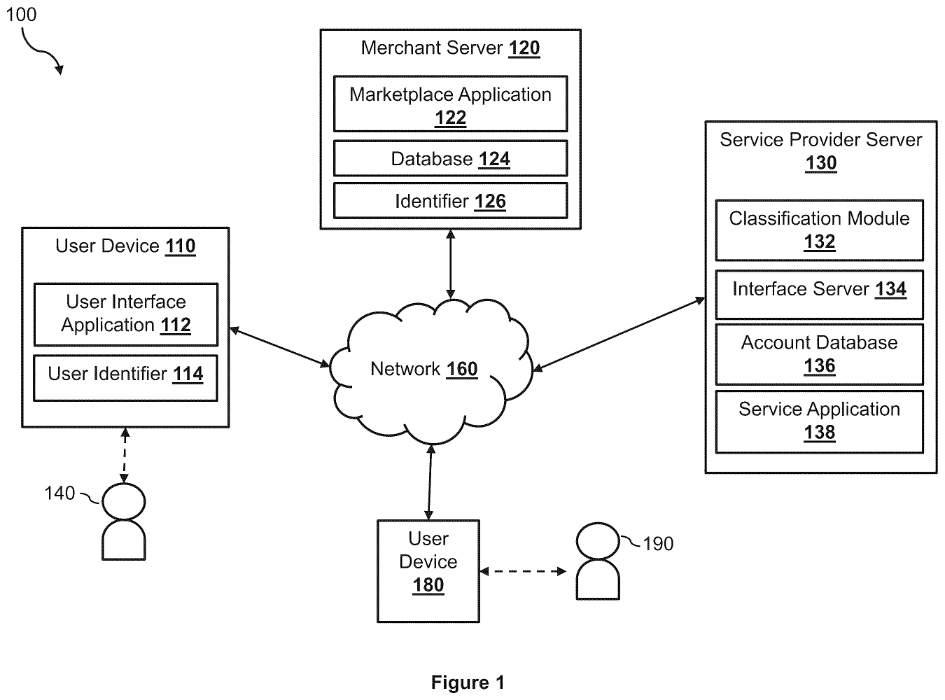

FIG. 1 illustrates a networked system 100, within which the classification system may be implemented according to one embodiment of the disclosure. The networked system 100 includes a service provider server 130, a merchant server 120, and user devices 110 and 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120, the user device 180, and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., account transfers, payments, data access, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120, the user device 180, and/or the service provider server 130 over the network 160. For example, via the UI application 112, the user 140 may submit a transaction request to the service provider server 130 (e.g., a request to register a user account, a request to log in to a user account, a fund transfer request, a request to access data hosted by the service provider server 130, etc.). In one implementation, the user interface application 112 includes a software program (e.g., a mobile application) that provides a graphical user interface (GUI) for the user 140 to interface and communicate with the service provider server 130, the user device 180, and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120, the user device 180, and/or the service provider server 130.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to add a new funding source, to perform an electronic purchase with a merchant associated with the merchant server 120, to provide information associated with the new funding account, to initiate an electronic payment transaction with the service provider server 130, to apply for a financial product through the service provider server 130, to access data associated with the service provider server 130, etc.).

The user device 180 may have similar components as the user device 110 and may enable a user 190 of the user device 180 to interact (perform transactions with) the merchant server 120, the user device 110, and the service provider server 130.

The merchant server 120, in various embodiments, may be maintained by a business entity (or in some cases, by a partner of a business entity that processes transactions on behalf of business entity). Examples of business entities include merchants, resource information providers, utility providers, real estate management providers, social networking platforms, etc., which offer various items for purchase and process payments for the purchases. The merchant server 120 may include a merchant database 124 for identifying available items or services, which may be made available to the user devices 110 and 180 for viewing and purchase by the user.

The merchant server 120, in one embodiment, may include a marketplace application 122, which may be configured to provide information over the network 160 to the user interface application 112 of the user device 110 and to the user device 180. In one embodiment, the marketplace application 122 may include a web server that hosts a merchant website for the merchant. For example, the user 140 of the user device 110 and the user 190 of the user device 180 may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user devices 110 and 180, and the service provider server 130 via the network 160.

The service provider server 130, in one embodiment, may be maintained by a transaction processing entity or an online service provider, which may provide processing for electronic transactions between the user 140 of user device 110, the user 190 of the user device 180, and one or more merchants. As such, the service provider server 130 may include a service application 138, which may be adapted to interact with the user devices 110 and 180, and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may interact with the service provider server via the user interfaces generated by the interface server 134. For example, a user may access various pages on a website of the service provider server 130, access a user account associated with the user, and access various services offered by the service provider server 130, by generating HTTP requests directed at the service provider server 130. In another example, the user 140 may submit a transaction request via the interface generated by the interface server 134. In some embodiments, each interaction of a user with the any one of the user interfaces associated with the online service provider 130 may constitute a distinct event that is associated with the user. As such, as a user (e.g., the user 140, the user 190, etc.) interacts with the service provider server 130 via the user interfaces generated by the interface server 134 over one or more sessions, various events may be recorded for the user. In some embodiments, sequences of events associated with different users with the service provider server 130 may be recorded and stored, to be used for classifying events for the users. Since different users may interact with the service provider server 130, different event sequences representing the different interactions of the users may be generated. For example, based on the interactions of the user 140 with a user interface of the service provider server 130 (e.g., via the user device 110), a first event sequence may be generated and stored for the user 140. Similarly, based on the interactions of the user 190 with the user interface of the service provider server 130 (e.g., via the user device 180), a second event sequence may be generated and stored for the user 190.

The service provider server 130, in one embodiment, may be configured to maintain one or more accounts (e.g., user accounts, merchant accounts, etc.) in an account database 136, each of which may be associated with a profile and may include account information associated with one or more individual users (e.g., the user 140 associated with user device 110, the user associated with the user device 180, etc.) and merchants. For example, account information may include user information such as a gender, an address, an education level, an income level, an email address, etc., financial information such as bank account identifiers, payment card identifiers, etc., credential information such as one or more account numbers, passwords, transaction history, device information such as an Internet Protocol (IP) addresses, a device identifier, a device type, etc., and other information related to the user account. In certain embodiments, account information of a user may also include event data representing an event sequence conducted by the user with the user interfaces of the service provider server 130. As such, the first event sequence and the second event sequence may be stored in the account database 136 for the users 140 and 190, respectively.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a classification module 132 that implements the classification system as discussed herein. The classification module 132 may be configured to classify events conducted by different users based on event sequences associated with the users. As discussed herein, as a user interacts with the service provider server 130 over a period of time (during one or more online sessions, etc.), event data associated with the interactions of the user with the service provider server 130 (also referred to as events) are recorded and stored (e.g., in the account database 136). The event data for each user may represent a sequence of events that have been conducted by the user in a chronological order. When a new event is conducted (e.g., when the user performs a new interaction with the service provider server 130, such as initiating a payment transaction via the user interface), the classification module 132 may use the event data to classify the event (e.g., determining whether the event is associated with fraudulent behavior). The classification of the event may then be provided to the interface server 134, such that the interface server 134 may provide a proper response to the event (e.g., authorizing the transaction, denying the transaction, locking the user out of a user account, etc.).

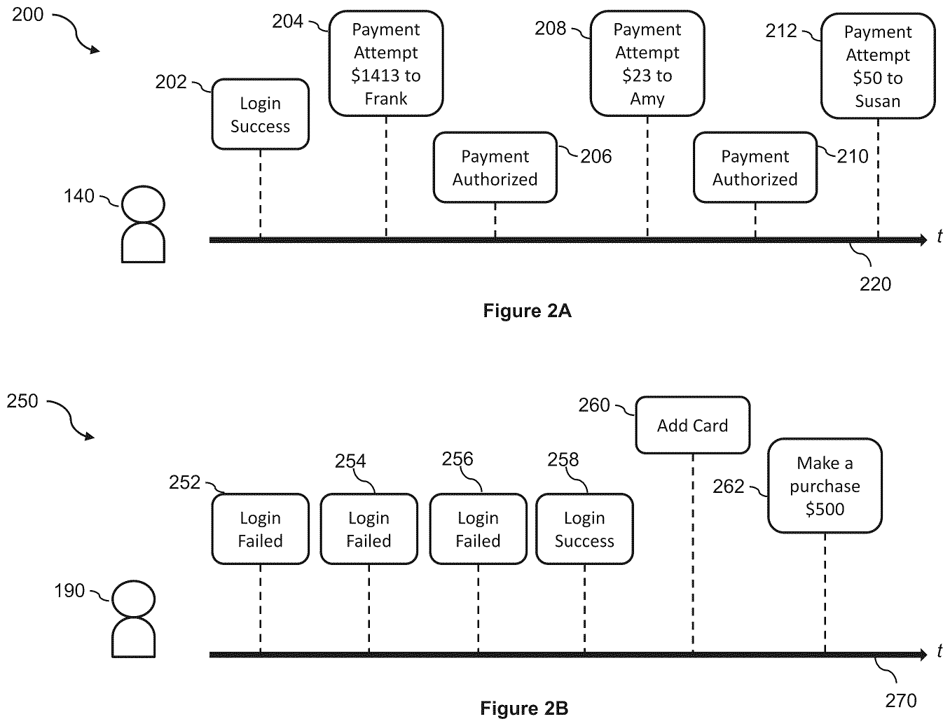

FIGS. 2A and 2B illustrate two example event sequences conducted by two different users 140 and 190 according to an embodiment of the disclosure. Specifically, FIG. 2A illustrates an event sequence 200 that represents events (or a portion of events) conducted by the user 140 with the service provider server 130. As shown, the event sequence 200 comprises multiple events 202, 204, 206, 208, 210, and 212 conducted by the user 140 over a period of time represented by a timeline 220. The period of time may overlap one or more online sessions between the user 140 and the service provider server 130. According to the event sequence 200, the user 140 first successfully logged in to a user account of the user 140 during the login success event 202. During the event 204, the user 140 initiated a payment transaction of $1,413 to Frank, and the payment transaction was authorized, as indicated by the payment authorized event 206. During the event 208, the user 140 initiated another payment transaction of $23 to Amy. The payment transaction to Amy was authorized, as indicated by the payment authorized event 210. The user 140 then initiated another payment transaction of $50 to Susan, as indicated by the event 212.

FIG. 2B illustrates a different event sequence 250 that represents events (or a portion of events) conducted by the user 190 with the service provider server 130. As shown, the event sequence 250 comprises multiple events 252, 254, 256, 258, 260, and 262 conducted by the user 180 over a period of time represented by a timeline 270. The period of time may overlap an online session between the user 180 and the service provider server 130. According to the event sequence 250, the user 140 failed to log in to a user account multiple times, as indicated by the login failed events 252, 254, and 256, before successfully logged in to the user account during the login success event 258. During the event 260, the user 140 added a new funding instrument (e.g., a new credit card) to the user account, and then initiated a purchase transaction for $500 using the new funding instrument, as indicated by the event 262.

Each of the event sequences 200 and 250 may be used and analyzed by the classification module 132 for classifying current events associated with the respective users 140 and 190. For example, after the user 140 initiated a payment transaction of $50 to Susan through the user account with the service provider server 130 (as indicated by the event 212), the classification module 132 may analyze the event sequence 200 to classify the event 212 (e.g., determining whether the payment transaction of $50 to Susan is associated with fraudulent behavior). Based on the event sequence 200, the classification module 132 may determine that the event 212 associated with the payment transaction of $50 to Susan is not likely to be associated with fraudulent behavior, and may authorize the payment transaction (or transmit the classification to the interface server 134 for authorizing the payment transaction). The authorization of the payment transaction to Susan may correspond to yet another event (not shown) that is recorded and added to the event sequence 200 associated with the user 140 by the classification module 132, and can be used by the classification module 132 in any future event classifications for the user 140.

In another example, for the user 190, the classification module 132 may be requested to classify the event 262 associated with initiating a purchase transaction using the newly added funding instrument. Based on the event sequence 250, the classification module 132 may determine that the event 262 is likely to be associated with fraudulent behavior, and may deny the purchase transaction (or transmit the classification to the interface server 134 for denying the purchase transaction). The classification module 132 may create another event associated with the denial of the purchase transaction, and may store the new event in the event sequence 250 associated with the user 190, such that the new event can be used to classify any future event for the user 190.

When analyzing the event sequences, the classification module 132 may derive one or more patterns associated with the event sequences associated with the various users, and may identify patterns that are associated with fraudulent behavior and patterns that are associated with legitimate behavior. In some embodiments, the classification module 132 may use one or more machine learning models (e.g., a transformer neural network, a long short-term memory (LSTM) neural network, etc.) that are configured to take inputs having a temporal dimension to perform the event classification. Each of the one or more machine learning models may be configured to accept an event sequence as input, and produce an output corresponding to a classification of an event. Since the classification prediction by the classification module is based on derivable patterns from the event sequences, a longer event sequence associated with a user (and provided to the classification module 132), may enable the classification module 132 to produce more accurate classification predictions for the user. As such, for users who interact with the service provider servers 130 at a high frequency (e.g., a frequency above a first frequency threshold), the classification module 132 may be capable of performing the event predictions with a high accuracy (e.g., an accuracy above an accuracy threshold). However, for users who do not interact with the service provider server 130 at such high frequency (e.g., a frequency below the first frequency threshold), the machine learning models used by the classification module 132 may not be able to produce acceptable accuracy results (e.g., an accuracy below the accuracy threshold).

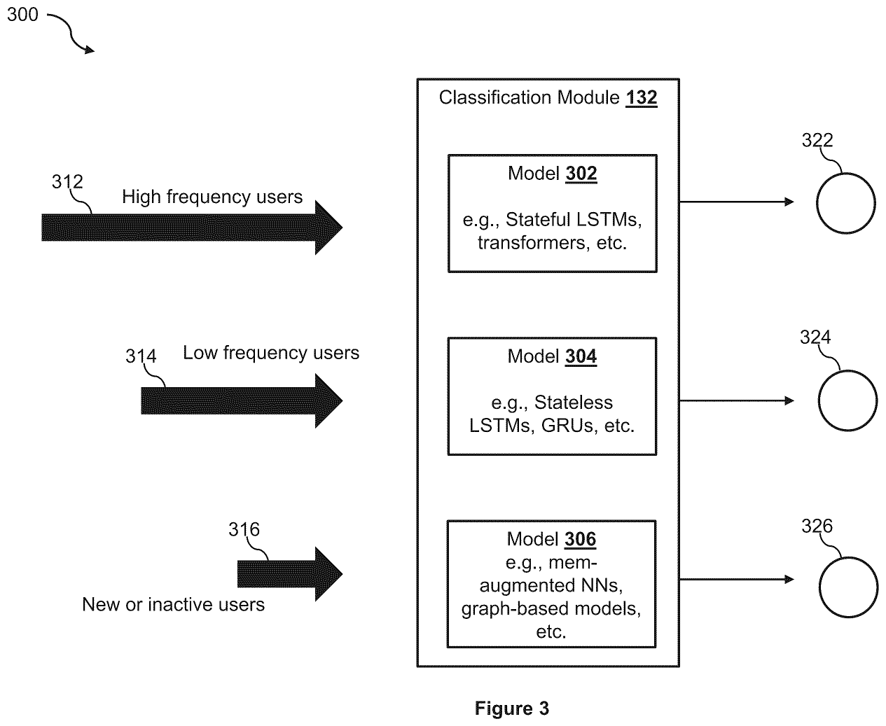

Thus, in order to improve the accuracy performance of the classification module 132, in some embodiments, the classification module 132 may include and select different machine learning models for classifying events associated with different users based on the users' interaction frequencies. FIG. 3 illustrates a use case 300 and a multi-model structure of the classification module 132 according to various embodiments of the disclosure for performing event classification for different types of users. As shown in FIG. 3, the classification module 132 includes three different models 302, 304, and 306. The classification module 132 may also assign each user to one of three different tiers 312, 314, and 316 based on the user's interaction frequency with the service provider server 130. Users who interact with the service provider server 130 at a high frequency (e.g., above the first frequency threshold) are assigned to the tier 312, users who interact with the service provider server 130 at a lower frequency (e.g., below the first frequency threshold but above a second frequency threshold) are assigned to the tier 314, and users who rarely interact with the service provider server 130 (e.g., new users or inactive/dormant users who interact with the service provider server 130 below the second frequency threshold) are assigned to the tier 316.

For the users assigned to the tier 312, the classification module 132 may use the model 302 for performing event classifications. The model 302 may be a machine learning model configured to accept input having a temporal dimension (e.g., accepting inputs of the same type multiple times corresponding to different points in time), such as a transform neural network or a stateful LSTM neural network that is capable of providing accurate classification predictions based on sufficient input data.

Since the users assigned to the tier 314 may not be associated with event sequences that are as long as those associated with the users in the tier 312, the classification module 132 may use a different model 304 for performing event classifications for the users assigned to the tier 314. The model 304 may also be configured to accept input having a temporal dimension. However, unlike the model 302, the model 304 may not rely as much on the long-term patterns of the event sequences. Example machine learning models that can be used to implement the model 304 may include a stateless LSTM neural model or a gated recurrent unit (GRU) neural network. Since the stateless LSTM neural model resets the memory of each batch of data, it does not rely on the long-term pattern in the event sequences as much as the stateful LSTM.

In general, stateless LSTMs and GRUs are computationally efficient (e.g., less complex structure, fewer parameters) and hence provide a distinct advantage at inference time than machine learning models having a more complex structure such as stateful LSTMs and transformers, especially when the overall operation involves loading the entire event sequence by account key, transforming the feature space (imputation, missing value replacement) and then computing a score based on the cascade. Since sequences for the users in the tier 314 are shorter (having less frequency events), we can expect greater temporal variance in customer activity. As young customers become mature users, using a temporal model with a complex structure (such as a stateful LSTM or a transformer with state transitions and large number of learning parameters) comes with explicit assumptions on how the sequence could evolve, and potentially overfitting, or issues with model performance stability. Stateless LSTMs and GRUs help in making fewer assumptions about how the sequence could evolve in the future and help with building a more robust model, with better performance guarantee for short-sequence event history.

For the users assigned to the tier 316, the classification module 132 may use the model 306 for performing event classification. Since the users in the tier 316 have an insufficient amount of event data for a machine learning model to produce an accurate classification prediction, the model 306 may be implemented in a manner such that additional data can be incorporated to enrich the existing event data of the users in performing the event classification. In some embodiments, the model 306 may be implemented using a memory-augmented neural network, where additional data (e.g., event data associated with other users, etc.) may be incorporated into the model 306 to enrich the event sequence of the user, in order to improve the accuracy performance of the model 306. As such, when performing event classification for a user assigned to the tier 316, the classification module 132 may first identify one or more other users who share one or more common attributes as the user. The classification module 132 may extract data from these other users (e.g., event attributes of events conducted by these users, etc.), and augment the model 306 using the extracted data. The classification module 132 may then provide the event sequence of the user to the model 306 that has been augmented with the data extracted from the other users, and obtain a classification output.

While three different models 302, 304, and 306 are used to implement the classification module 132 in this example, it has been contemplated that any number of models can be used for the classification module 132, and the users can be segregated into the corresponding number of tiers for using the different models in performing the event classification.

Each of the models 302, 304, and 306 is configured to provide a classification output (e.g., outputs 322, 324, and 326, respectively) based on an event sequence associated with a user. The outputs may indicate a classification of an event associated with a corresponding user. Thus, when the classification receives a request to classify an event associated with a user (e.g., the event 212 associated with the user 140), the classification may retrieve (or generate) an event sequence associated with the user 140. Since the service provider server 130 may have recorded and stored event data associated with each of its users for a long period of time (e.g., since the creation of a user account of the user which may include a period of time as long as several years or more), the classification module 132 may potentially generate a long event sequence that encompasses the entire history of the user interacting with the service provider server 130. Naturally, the long event sequence may help with the accuracy performance of the classification module 132. However, a very lengthy event sequence (a large volume of event data) may also translate to longer processing time for predicting the event classification. As such, using the entire lifespan of the interactions between the user and the service provider server 130 for classifying every single event may not be efficient or result in a more accurate prediction than using a shorter event sequence. Lengthy event sequences may also yield inaccurate predictions if aged or older data no longer accurately represents the user.

As such, in some embodiments, the classification module 132 may determine different periods of time for generating the event sequence based on characteristics of the event to be classified. For example, a longer period of time (e.g., several months, a year, etc.) may be used for generating the event sequence when the event is associated with a higher risk (e.g., accessing highly sensitive data, processing a payment transaction of an amount that exceeds a threshold, etc.), and a shorter period of time (e.g., several days, several weeks, etc.) may be used for generating the event sequence when the event is associated with a lower risk (e.g., accessing data in the public domain, processing a payment transaction of an amount below a threshold, etc.). After determining the period of time, the classification module 132 may generate an event sequence for the user 140, that represents events conducted by the user 140 with the service provider server 130 during the period of time.

As discussed herein, the event sequence comprises events conducted by the user 140 in a chronological order within a period of time. In some embodiments, the event sequence includes event data for each event, which may include event attributes such as a point in time when the event was conducted, an event type associated with the event, attributes associated with the corresponding event (e.g., an amount associated with a payment transaction event, credential data used in a login attempt event, a link being selected by a user in a browsing event, etc.), and/or other information related to the event.

In some embodiments, the classification module 132 may also select, from the different models 302, 304, and 306, a particular model for performing the event classification for the user 140 based on the interaction frequency between the user 140 and the service provider server 130. If the interaction frequency is above the first frequency threshold, the classification module 132 may assign the user 140 to the tier 312, and the classification module 132 may provide the event sequence to the model 302 and obtain a classification output 322 from the model 302. If the interaction frequency is below the first frequency threshold but above the second frequency threshold, the user 140 may be assigned to the tier 314. The classification module 132 may provide the event sequence to the model 304 and obtain a classification output 324 from the model 304. On the other hand, if the interaction frequency is below the second frequency threshold, the user 140 may be assigned to the tier 316. Being assigned to the tier 316 indicates that the user is either a new user or an inactive user. As such, the classification module 132 may identify one or more other users who share one or more attributes with the user 140 (e.g., same demographic, located in the same region, etc.), and may extract data from the other users. The data that is extracted from the other users and incorporate into the model 306 may include IP addresses used by the other users, cookie identifiers of the other users, device information (e.g., app guid, device and carrier information, etc.) of the other users, geo-locations of the other users, funding instrument attributes (e.g., credit card numbers, bank information, etc.) of the other users, browser information (e.g., plugins, types of browsers, screen resolution, type of hardware, version of the browser, etc.) of the other users, and possibly other types of information.

The classification module 132 may augment the model 306 using the data extracted from the other users, and then provide the event sequence associated with the user 140 to the model 306 to obtain the classification output 326.

While the memory augmented model 306 provides improvement to the accuracy of the classification prediction for the users in the tier 316, it may still be incapable of performing at a desirable level (e.g., having an accuracy above an acceptable threshold, etc.). As such, in some embodiments, for the users assigned to the tier 316, the classification module 132 may incorporate event sequences into a graph-based structure for performing event classification, and may use at least a portion of the graph-based structure to perform the event classification. For example, the classification module 132 may access a transaction graph associated with the service provider server 130. The transaction graph represents transactions (or transaction attempts) conducted between different users of the service provider server 130, such that nodes representing users who have conducted transactions with each other are connected with an edge in the transaction graph.

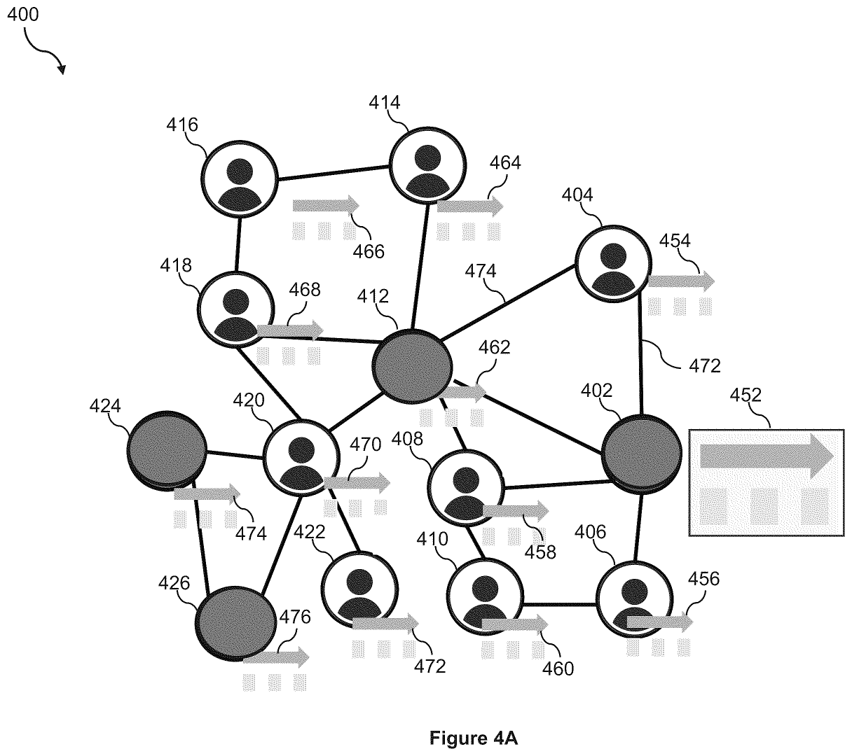

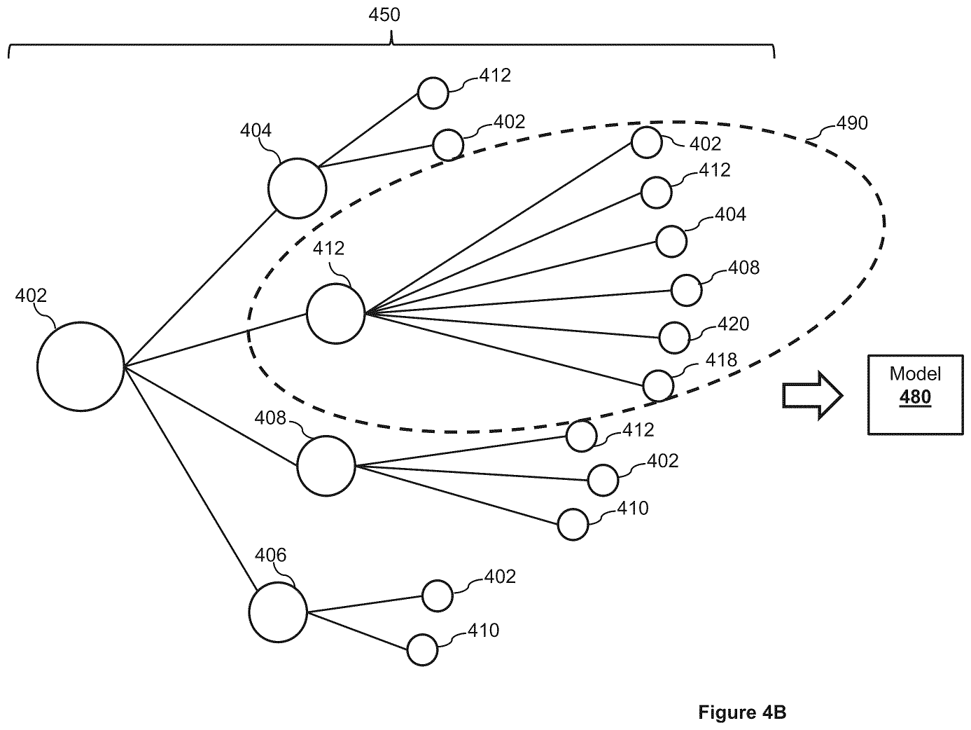

FIG. 4A illustrates an example graph 400 according to one embodiment of the disclosure. As shown, the graph 400 includes multiple nodes 402, 404, 406, 408, 410, 412, 414, 416, 418, 420, 422, 426, and 428, representing different users of the service provider server 130 (or user accounts of the users). The graph 400 may also include edges (e.g., edges 472, 474, etc.) representing connections among various users (e.g., through various user accounts with the service provider server 130). For example, the edge 472 represents one or more connections between a user represented by the node 402 and a user represented by the node 404, and the edge 474 represents one or more connections between the user represented by the node 404 and the user represented by the node 412. The connections may indicate a relationship between the corresponding users (e.g., family, friends, co-workers, etc.) or transactions conducted between the corresponding users. As such, some of the connections can be directional (e.g., an edge that represents User ‘A’ sending a payment to User ‘B’). Thus, the edges in the graph 400 can be non-directional, unidirectional, or bi-directional.

Each of the nodes in the graph 400 may store (or be associated with) data associated with the corresponding user (e.g., demographic information, income information, residence information, etc.). Similarly, each of the edges in the graph 400 may store (or be associated with) data associated with the corresponding connection (e.g., a type of relationship, an amount associated with the transaction, a volume of transactions, a frequency of transactions, etc.). In some embodiments, the classification module 132 may retrieve event data associated with each user, and incorporate the event data (e.g., as an event sequence) of the users into the respective nodes in the graph 400. For example, the classification module 132 may determine that the node 402 represents the user 140. The classification module 132 may then access the event data associated with the user 140 (e.g., from the account database 136), and may incorporate the event data, (e.g., as an event sequence 452) into the node 402 of the graph 400. Similarly, the classification module 132 may access event data of the different users with the service provider server 130, and may incorporate the event sequences (e.g., event sequences 454, 456, 458, 460, 462, 464, 466, 468, 470, 472, 474, and 476) into the respective nodes (e.g., the nodes 404, 406, 408, 410, 412, 414, 416, 418, 420, 422, 424, and 426) of the graph 400. In some embodiments, the classification module 132 may update the event sequences in the graph 400 based on updated event data associated with the users (e.g., new events conducted by the users, etc.). For example, the classification module 132 may periodically access the account database 136 to determine if updated event data is available for any of the users. If updated data is available for a user, the classification module 132 may update the event sequence associated with the user, and incorporate the updated event sequence into the corresponding node in the graph 400.

In some embodiments, when the classification module 132 receives a request to classify an event associated with a user (e.g., the user 140) and determines that the user is assigned to the tier 316 based on the event sequence of the user, the classification module 132 may use the graph 400 (or a portion of the graph 400) to classify the event associated with the user. For example, upon receiving the request, the classification module may first determine, from the graph 400, a node that represents the user 140. In this example, the classification module 132 may determine that the node 402 represents the user 140. The classification module 132 may then identify users that are related to the user 140 based on the connections in the graph 400. For example, the classification module 132 may determine a first layer of nodes (including the nodes 404, 412, 408, and 410) that are related to the node 402 based on a direct connection between the node 402 and the nodes 404, 412, 408, and 410. In some embodiments, the classification module 132 may determine a second layer of nodes (including the nodes 402, 404, 408, 410, 412, 418, and 420) that are related to the first layer of nodes based on the direct connections between the nodes in the first layer and the nodes in the second layer.

As discussed herein, the classification module 132 is likely to produce more accurate classification of the event when more data (e.g., more layers of nodes) are included in the analysis. However, additional layers of nodes also increase the complexity of the analysis, and would likely increase the processing resources and an amount of time required to perform the event classification, while not necessarily resulting in a more accurate prediction. As such, determining the number of layers of nodes to be included in the analysis is a balancing act between accuracy of the classification and the computer resources (and the amount of time) required to perform the classification. In some embodiments, the classification module 132 may determine a number of layers of nodes (in other words, a number of hops from the node 402 representing the user 140) to use for classifying the event associated with the user 140, based on attributes of the user 140 and/or the event (e.g., a risk level of the event, a risk level of the user 140, etc.). The higher the risk level (of the user and/or the event), the more layers of nodes to be included. Similarly, the lower the risk level (of the user and/or the event), the more layers of nodes to be included. Reliability of older data may also be determined, such that if such data is no longer reliable or accurately represent the user, that data may not be selected for use as part of the event sequence.

In this example, the classification module 132 may determine to include two layers of nodes from the node 402 (e.g., nodes that are within two hops from the node 402 in the graph 400) for classifying the event associated with the user 140. However, in other examples where the event and/or the user may be associated with a different risk level, the classification module 132 can determine to include more than two (or less than two) layers of nodes to be included in the analysis.

After identifying the related nodes within the graph 400, the classification module 132 may extract a portion of the graph 400 that includes the node 402, the first layer of nodes, and the second layer of nodes for classifying the event associated with the user 140. FIG. 4B illustrates a graph 450 that represents the extracted portion of the graph 400 in an expanded tree format. As shown, the graph 450 includes the node 402 as the root node of the graph 450. The graph 450 also includes the first layer of nodes 404, 412, 408, and 406 connected to the node 402. The graph 450 also shows that the second layer of nodes 402, 404, 408, 410, 412, 418, and 420 are connected to the first layer of nodes. Specifically, the graph 450 shows that the nodes 412 and 402 of the second layer are connected to the node 404 of the first layer, the nodes 402, 412, 404, 408, 420, and 418 of the second layer are connected of the node 412 of the first layer, the nodes 412, 402, and 410 of the second layer are connected of the node 408 of the first layer, and the nodes 402 and 410 of the second layer are connected of the node 406 of the first layer.

In some embodiments, if the event sequences of the different users are not already incorporated into the graph, the classification module 132 may access the event data associated with the users represented by the nodes in the graph 450, and incorporate the event data as event sequences into the respective nodes of the graph 450. As discussed herein, in general, the more nodes included in the graph 450 (in other words, the more users, that are related to the user 140, are included in the analysis), the more accurate the classification is for the event. However, in some scenarios, the inclusion of certain users (or user accounts) in the analysis may have a detrimental effect to the classification. For example, it is conceivable that the user 140 (or other related users) may have conducted transactions with a large volume merchant (e.g., a merchant that have sales volume above a threshold). The node representing the large volume merchant may be connected to a large number of other nodes (due to the large number of consumer-base associated with the large volume merchant). However, the inclusion of the node representing the large volume merchant and the nodes that are connected to the large volume merchant may not be beneficial to the classification of the event associated with the user 140 because the relationship between the user 140 and the large volume merchant, and the relationships between the user 140 and the other consumers of the large volume merchant are presumably weak, and the inclusion of such a large group of nodes (including the node representing the large volume merchant and potentially the nodes of the consumers of the large volume merchant) will significantly increase the computer processing resources required to perform the event classification. As such, in some embodiments, the classification module 132 may remove a branch of the graph 450 associated with the large volume merchant. For example, if it is determined that the node 412 represents a large volume merchant, the classification module 132 may remove a portion 490 (which includes the node 412 and any other nodes downstream from the node 412) and also other nodes 412 from the graph 450.

The classification module 132 may then provide the graph 450 as input data to a model 480. In some embodiments, the model 480 is a graph-based machine learning model that is configured and trained to analyze graph data and produce an output corresponding to a classification of an event. In some embodiments, the model 480 may first analyze the node 402 representing the user 140. For example, the model 480 may compute a first score based on the event sequence 452 embedded within the node 402, and other attributes of the user 140 stored in the node 402. The model 480 may then compute a second score based on the event sequences (e.g., the event sequences 454, 458, and 456, since the node 412 has been removed) embedded within the first layer of nodes (e.g., the nodes 404, 408, and 406), and attributes of the users stored in the first layer of nodes. In some embodiments, the model 480 may apply a first weight to the second score. In some embodiments, the first weight may be determined based on the edges that connect the node 402 to the first layer of nodes. For example, the model 480 may determine a higher value for the first weight when edges connecting the node 402 and the first layer of nodes indicate stronger connections (e.g., higher volume and/or frequency of transactions between the user 140 and the users represented by the first layer of nodes). The model 480 may then compute a third score based on the event sequences (e.g., the event sequences 452 and 460 since the node 412 is removed) and attributes of the users represented by the nodes 402 and 410. In some embodiments, the model 480 may apply a second weight to the third score. The second weight can also be determined in a similar manner as the first weight, based on the connectedness between the first layer of nodes and the second layer of nodes.

In some embodiments, the weight being applied to a score is smaller when the layer of nodes is farther away from the node 402. Thus, the second weight may always be smaller than the first weight. The model 480 may then compute a final score (the output value) based on the different weighted scores. The final score may indicate whether the event conducted by the user 140 is associated with fraudulent activities.

In some embodiments, the classification module 132 may use the output from the model 480 to determine a classification for the event (e.g., whether the event is associated with fraudulent activities). The classification module 132 may provide the classification to the interface server 134, such that the interface server 134 may respond to the event. For example, when the event is associated with a login attempt, the interface server 134 may authorize or deny the login attempt based at least in part on the classification provided by the classification module 132. In some embodiments, when the classification for the event indicates a strong likelihood of fraudulent activities, the interface server 134 may deny the login attempt even when the credentials received from the user 140 is correct for the user account. In another example, when the event is associated with an initiation of a payment transaction, the interface server 134 may authorize or deny the payment transaction based at least in part on the classification provided by the classification module 132.

As discussed herein, since the classification module 132 can perform the classification of events in real-time by using the techniques disclosed herein, the classification module 132 may cooperate with the interface module 134 to continuously classify various events for the users, as the events are being conducted. Thus, as a user (e.g., the user 140) begins interacting with the service provider server 130 (e.g., by conducting different interactions with the user interface provided by the service provider server 130), the user 140 is being evaluated at each event (e.g., the user 140 selecting a user interface element on the user interface, the user 140 initiating a transaction attempt, such as a payment attempt, an attempt to add a funding source, etc.) by the classification module 132. The classification module 132 may classify the different events conducted by the user 140 within the session, and may update the event sequence (e.g., the event sequence 452) of the user 140 after each event. By evaluating the user 140 at each event conducted by the user (instead of evaluating the user 140 only at critical events such as login events, payment transaction events, etc.), the activities of the user 140 can be monitored closely. Furthermore, if the user 140 is a malicious user, the classification module 132, and hence the service provider server 130, can detect it faster based on the continuous evaluation of the events associated with the user 140. For example, the malicious intent of the user 140 may be detected while the user 140 is conducting non-critical events (e.g., browsing the website of the service provider server 130) and the classification module 132 and/or the interface server 134 may be able to respond to the detection (e.g., locking the user 140 out of a user account, locking the user 140 out of the user interface, etc.) before the user 140 initiates a critical event that would detrimentally affect the service provider server 130 and/or other users of the service provider server 130 (e.g., initiating a payment transaction). As such, using the classification techniques disclosed herein, the network security of the service provider server 130 can be significantly improved.

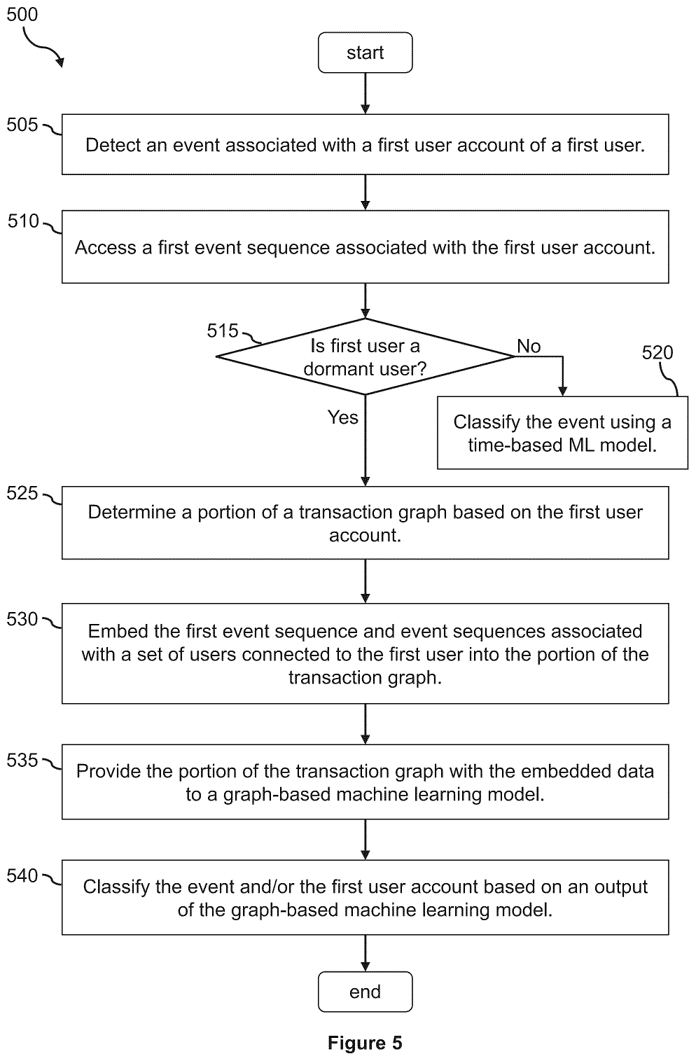

FIG. 5 illustrates a process 500 for performing event classifications for inactive and/or dormant users according to various embodiments of the disclosure. In some embodiments, at least a portion of the process 500 may be performed by the classification module 132. The process 500 begins by detecting (at step 505) an event associated with a first user account of a first user. For example, as a user (e.g., the user 140) interacts with a user interface (e.g., a website, a mobile application) of the service provider server 130, the interface server 134 may detect events conducted by the user. Each event may correspond to an interaction between the user 140 and the user interface of the service provider server 130, such as a selection of a user interface element on a user interface page, an initiation of a transaction (e.g., a login transaction, a payment transaction, a data access transaction, etc.), or other types of interactions.

The process 500 then accesses (at step 515) a first event sequence associated with the first user account and determines (at step 520) whether the first user is a dormant user. For example, the classification module 132 may access event data associated with the user 140, and may generate an event sequence (e.g., the event sequence 452). The event sequence 452 may include events conducted by the user 140 during a period of time, including the detected event, in a chronological order. Based on the event sequence, the classification module 132 may determine whether the user 140 is an inactive and/or dormant user. An inactive and/or dormant user is a user whose interaction frequency with the service provider server 130 falls below a particular threshold.

If it is determined that the first user is not a dormant user, the process 500 classifies (at step 520) the event using a time-based machine-learning model. For example, when the classification module 132 determines that the user 140 is not an inactive and/or dormant user, the classification module 132 may provide the event sequence 452 generated for the user 140 to a time-based machine learning model. In some embodiments, different time-based machine learning models may be used for classifying the event based on the interaction frequency of the user 140. For example, the classification module 132 may select, from the models 302 and 304, a machine learning model for classifying the event based on the interaction frequency of the user 140. When the interaction frequency of the user 140 exceeds a particular threshold, the classification module 132 may use the model 302 to classify the event for the user. On the other hand, when the interaction frequency of the user 140 falls below the particular threshold, the classification module 132 may use the model 304 to classify the event for the user.

If it is determined that the first user is a dormant user, the process determines (at step 525) a portion of a transaction graph based on the first user account and embeds (at step 530) the first event sequence and event sequences associated with a set of users connected to the first user into the portion of the transaction graph. For example, the classification module 132 may access the graph 400 that represents transactions conducted among the users of the service provider server 130. The classification module 132 may identify a node (e.g., the node 402) in the graph 400 that represents the user 140, and may determine nodes that are related to the node 402 based on the connections (e.g., edges) in the graph 400. For example, the classification module 132 may determine that nodes within two hops from the node 402 representing the user 140 are related to the node 402.

Each node within the graph 400 may include data associated with the corresponding user (or user account), and each edge within the graph 400 may include transaction data associated with the corresponding transaction. In some embodiments, the classification module 132 may embed additional information into the graph. For example, the classification module 132 may embed the event sequence 452 associated with the user 140 into the node 402 representing the user 140. The classification module 132 may also obtain (or generate) event sequences associated with users that are represented by the nodes determined to be related to the node 402, and embed the event sequences into the respective nodes in the graph 400.

The process 500 then provides (at step 535) the portion of the transaction graph with the embedded data to a graph-based machine learning model and classifies (at step 540) the event and/or the first user account based on an output of the graph-based machine learning model. For example, the classification module 132 may generate the graph 450, which represents a portion of the graph 400 that is determined to be related to the user 140. The graph 450, in some embodiments, is in an expanded tree format having the node 402 representing the user 140 as the root node, and shows the different layers of nodes that are connected to the node 402 within the graph 400. The classification module 132 may provide the graph 450 to the model 480, and may obtain an output from the model 480. The classification module 132 may then classify the event associated with the user 140 based on the output of the model 480.

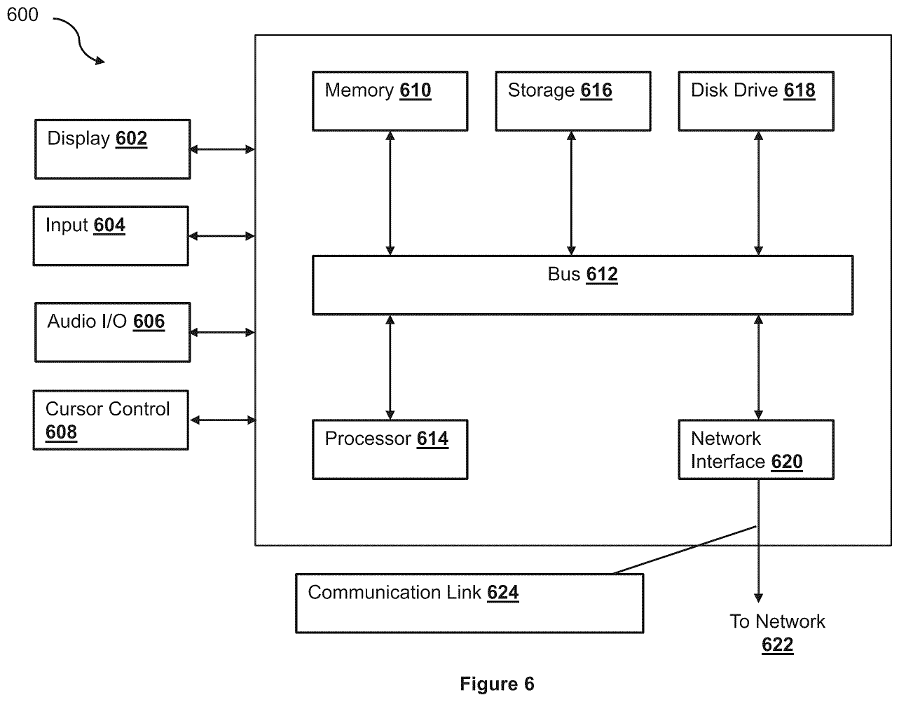

FIG. 6 is a block diagram of a computer system 600 suitable for implementing one or more embodiments of the present disclosure, including the service provider server 130, the merchant server 120, and the user devices 110 and 180. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 180, 120, and 130 may be implemented as the computer system 600 in a manner as follows.

The computer system 600 includes a bus 612 or other communication mechanism for communicating information data, signals, and information between various components of the computer system 600. The components include an input/output (I/O) component 604 that processes a user (i.e., sender, recipient, service provider) action, such as selecting keys from a keypad/keyboard, selecting one or more buttons or links, etc., and sends a corresponding signal to the bus 612. The I/O component 604 may also include an output component, such as a display 602 and a cursor control 608 (such as a keyboard, keypad, mouse, etc.). The display 602 may be configured to present a login page for logging into a user account or a checkout page for purchasing an item from a merchant. An optional audio input/output component 606 may also be included to allow a user to use voice for inputting information by converting audio signals. The audio I/O component 606 may allow the user to hear audio. A transceiver or network interface 620 transmits and receives signals between the computer system 600 and other devices, such as another user device, a merchant server, or a service provider server via a network 622. In one embodiment, the transmission is wireless, although other transmission mediums and methods may also be suitable. A processor 614, which can be a micro-controller, digital signal processor (DSP), or other processing component, processes these various signals, such as for display on the computer system 600 or transmission to other devices via a communication link 624. The processor 614 may also control transmission of information, such as cookies or IP addresses, to other devices.

The components of the computer system 600 also include a system memory component 610 (e.g., RAM), a static storage component 616 (e.g., ROM), and/or a disk drive 618 (e.g., a solid-state drive, a hard drive). The computer system 600 performs specific operations by the processor 614 and other components by executing one or more sequences of instructions contained in the system memory component 610. For example, the processor 614 can perform the event classification functionalities described herein, for example, according to the process 500.

Logic may be encoded in a computer readable medium, which may refer to any medium that participates in providing instructions to the processor 614 for execution. Such a medium may take many forms, including but not limited to, non-volatile media, volatile media, and transmission media. In various implementations, non-volatile media includes optical or magnetic disks, volatile media includes dynamic memory, such as the system memory component 610, and transmission media includes coaxial cables, copper wire, and fiber optics, including wires that comprise the bus 612. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 600. In various other embodiments of the present disclosure, a plurality of computer systems 600 coupled by the communication link 624 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a non-transitory memory; and
one or more hardware processors coupled with the non-transitory memory and configured to read instructions from the non-transitory memory to cause the system to perform operations comprising:
detecting a first event of a first event type via a website associated with a service provider, wherein the first event is related to an interaction by a first user with the web site;
determining a first event sequence associated with the first user, wherein the first event sequence comprises a series of events associated with the first user;
traversing a transaction graph representing transactions conducted among different users with the service provider;
identifying, from the traversing, a portion of the transaction graph that includes a first node representing the first user and a set of nodes representing a set of users having conducted transactions with the first user;
determining a set of event sequences associated with the set of users;
embedding data associated with the first event sequence and the set of event sequences into the portion of the transaction graph;
providing the portion of the transaction graph with the embedded data as an input to a graph-based machine learning model; and
classifying the first event based on an output from the graph-based machine learning model.

2. The system of claim 1, wherein the operations further comprise:
determining that the first event sequence fails to satisfy a quantity threshold, wherein the traversing of the transaction graph is responsive to the determining that the first event sequence fails to satisfy the quantity threshold.

3. The system of claim 1, wherein the series of events includes at least a second event of a second event type different from the first event type.

4. The system of claim 1, wherein the graph-based machine learning model is trained to classify the first event based on the first event sequence, the set of event sequences, and relationships between the first user and the set of users according to the transaction graph.

5. The system of claim 1, wherein the embedding comprises:
embedding first data associated with the first event sequence into the first node representing the first user; and
embedding event data associated with each event sequence from the set of event sequences into a corresponding node from the set of nodes.

6. The system of claim 1, wherein the operations further comprise:
identifying, from the set of users, a second user having a transaction volume exceeding a threshold; and
removing a second node representing the second user from the portion of the transaction graph.

7. The system of claim 1, wherein the first type of event is one of a login event, an event associated with adding a funding instrument, or an event associated with linking a first user account of the first user with the service provider to a bank account.

8. A method, comprising:
detecting, by a computer system, a first event of a first event type via a user interface associated with a service provider, wherein the first event represents an interaction by a first user with the user interface;
obtaining a first event sequence associated with the first user, wherein the first event sequence comprises a series of events conducted by the first user within a predetermined time period;
determining that the first event sequence indicates a frequency of interactions between the first user and the service provider not exceeding a threshold;
in response to determining that the first event sequence indicates the frequency of interactions not exceeding the threshold:
identifying, within a graph representing connections among different users with the service provider, a portion of the graph for analyzing the first event, wherein the portion of the graph comprises a first node representing the first user and a set of nodes representing a set of users directly connected with the first node;
determining a set of event sequences associated with the set of users;
embedding, by the computer system, the first event sequence into the first node of the graph and the set of event sequences into respective nodes in the set of nodes of the graph; and
providing, by the computer system, the portion of the graph with the embedded event data as an input to a machine learning model; and
classifying, by the computer system, the first event based on an output from the machine learning model.

9. The method of claim 8, wherein the set of users is a first set of users, wherein the set of nodes is a first set of nodes, and wherein the portion of the transaction graph further comprises a second set of nodes representing a second set of users directly connected with the first set of nodes.

10. The method of claim 8, wherein the machine learning model is configured to (i) generate a first score based on the first event sequence embedded into the first node and a second score based on the set of event sequences embedded into the set of nodes, and (ii) generate the output based on the first score and the second score.

11. The method of claim 10, wherein the second score is generated further based on a set of connections connecting the first node to the set of nodes.

12. The method of claim 8, wherein the series of event is arranged in a chronological order in the first event sequence.

13. The method of claim 8, wherein the series of events includes at least a second event of a second event type different from the first event type.

14. The method of claim 8, wherein the machine learning model is trained to classify the first event based on the first event sequence, the set of event sequences, and relationships between the first user and the set of users according to the graph.

15. A non-transitory machine-readable medium having stored thereon machine-readable instructions executable to cause a machine to perform operations comprising:
detecting a first event associated with a first interaction between a first user and a user interface associated with a service provider;
determining a first event sequence associated with the first user, wherein the first event sequence represents a series of interactions of the first user with the user interface;
determining, based on the first event sequence, that an interaction frequency of the first user with the service provider is below a threshold;
in response to determining that the interaction frequency of the first user is below the threshold, accessing a graph-based model for classifying the first event;
identifying, from a graph representing transactions conducted among different users with the service provider, a portion of the transaction graph that includes a first node representing the first user and a set of nodes representing a set of users connected with the first node;
embedding the first event sequence and a set of event sequences associated with the set of users into the portion of the transaction graph;
providing the portion of the transaction graph as an input to the graph-based machine learning model; and
classifying the first event based on an output from the graph-based machine learning model.

16. The non-transitory machine-readable medium of claim 15, wherein the determining that the interaction frequency of the first user is below the threshold is further based on a volume of interactions in the first event sequence.

17. The non-transitory machine-readable medium of claim 15, wherein the first event corresponds to a first interaction type between the first user and the user interface, and wherein the first event sequence includes at least a second event corresponding to a second interaction type between the first user and the user interface different from the first interaction type.

18. The non-transitory machine-readable medium of claim 15, wherein the graph-based machine learning model is trained to classify the first event based on the first event sequence, the set of event sequences, and relationships between the first user and the set of users according to the transaction graph.

19. The non-transitory machine-readable medium of claim 15, wherein the embedding comprises:
embedding the first event sequence into the first node representing the first user; and
embedding event each event sequence in the set of event sequences into a corresponding node from the set of nodes.

20. The non-transitory machine-readable medium of claim 1, wherein the operations further comprise:
identifying, from the set of users, a second user having a transaction volume exceeding a threshold; and
removing a second node representing the second user from the portion of the transaction graph.
